(19) United States
(12) Patent Application Publication
(10) Pub. No.: US 2011/0271096 A1
(43) Pub. Date: Nov. 3, 2011

(54) Loosely-Coupled Encryption Functionality for Operating Systems

(75) Inventors: Shaun Jaikarran Bharrat, Manalapan, NJ (US); Damascene M. Joachimpillai, Westford, MA (US)

(73) Assignee: Sonus Networks, Inc., Westford, MA (US)

(21) Appl. No.: 12/770,473

(22) Filed: Apr. 29, 2010

(51) Int. Cl. H04L 29/06

(52) U.S. Cl. 713/153

(57) ABSTRACT

Described are computer-based methods and apparatuses, including computer program products, for loosely-coupled encryption functionality for operating systems. A data packet is processed through one or more internet protocol stack layers to generate a processed data packet. Encryption information is determined that includes parameters for encrypting and decrypting data packets transmitted between the first computing device and the remote computer. A message comprising data indicative of the encryption information is transmitted to a second computing device, wherein an operating system being executed is unaware of a security nature of the transmission. A bypass encryption routine is executed to generate a unencrypted data packet, wherein the bypass encryption routine does not encrypt the processed data packet. The unencrypted data packet is transmitted to the second computing device. The unencrypted data packet is encrypted based on the message transmitted from the first computing device to generate an encrypted data packet.

### CROSS REFERENCES TO RELATED APPLICATIONS

This application relates to and is assigned to the same entity as the co-pending application identified by Attorney Docket No. SNS-056B, entitled “Loosely-coupled Encryption Functionality for Operating Systems,” U.S. patent application Ser. No. TBD, filed on Apr. 29, 2010, the disclosure of which is hereby incorporated herein by reference in its entirety.

### FIELD OF THE INVENTION

The invention relates generally to computer-based methods and apparatuses, including computer program products, for loosely-coupled encryption functionality for operating systems.

### BACKGROUND

When communicating over unsecure networks, it is often desirable to protect packets transmitted across the unsecure networks. Internet Protocol Security (IPsec), as defined by the Internet Engineering Task Force (IETF) Requests for Comments (RFCs) 4301-4309, is an example of a widely used encryption suite for securing communications between two internet protocol (IP) nodes. IPsec can authenticate and encrypt each IP packet of a data stream transmitted from a host IP node to a remote IP node. There are numerous implementations of IPsec, both in software and hardware. On the software side, most off-the-shelf operating systems provide support for the negotiation of IPsec associations and/or the encryption/decryption of the data stream on those associations. On the hardware side, there are boards and processors that can perform the encrypt/decrypt at enormous throughput. In particular, an operating system (OS) coupled with any of several encrypt/decrypt accelerator boards can serve as a high-performance IPsec solution for many applications.

For example, the Linux OS (e.g., Linux 2.6) provides a rich implementation of IPsec through the XFRM framework that includes a Security-Association-Database (SAD), a Security-Policy-Database (SPD), and serveral encryption algorithms. The SAD contains security associations (SAs), which are sets of security information that describe a particular kind of secure connection between one device and another. The SPD stores security policies, which are rules programmed into the IPsec implementation that describe how to process different data packets received by the device. For example, security policies are used to decide if a particular data packet needs to be processed by IPsec or not, and if so, the security policies provide general guidelines for how the IPsec processing is done. The Linux IPsec implementation also includes a scatter/gather type application programmer interface (API) for interfacing with either user-provided software encryption/decryption modules or external hardware for encryption/decryption assist. The set of communications protocols used for the Internet and other similar networks can be generalized into the IP protocol suite layers, which include: the Application Layer (e.g., HTTP), the Transport Layer (e.g., TCP, UDP), the Internet Layer (e.g., IP), the Link Layer (e.g, Ethernet), and the Physical Layer (e.g., IEEE 802.3u). The XFRM framework logically sits as a layer of functionality between the Internet Layer and the Link Layer drivers.

The XFRM framework provides automatic checking of input and output data packets against the SPD and the SAD, callouts through a kernel/user interface to a key management application to request negotiation of SA information, support for several user-space key management applications (e.g., including Pluto, Isakmpd, and Racoon from the OpenSwan, OpenBSD, and Kame projects, respectively), APIs to user-definable encryption software or hardware (e.g., an encryption module), and implementations of numerous encryption protocols (e.g., Triple Data Encryption Standard (3DES), Advanced Encryption Standard (AES), Blowfish, Twofish, and others). Logically, the flow between the operating system and the encryption module can be thought off as a sidebar when the packet is flowing down the IP protocol layers (on output) or up the IP protocol layers (on input). For example, after the XFRM framework of a Linux OS determines the SA (e.g., locates the SA in the SAD or negotiates a SA for a first packet for a connection), and the relevant keying information is determined, the operating system transmits the packet (e.g., as a list of memory buffers) and the keying information to the encryption module (e.g., an encrypt API routine). When the encryption module completes encryption, the operating system collects the encrypted packet (as a list of memory buffers) and continues the output processing (e.g., processing the encrypted packet through the remaining IP layers).

The XFRM framework supports both a transport mode and a tunnel mode for IPsec. In transport mode, the original IP source and destination addresses are unchanged by the transform, and just the IP contents are encrypted. In tunnel mode, the original packet, including the IP header, is encapsulated in another IP packet with its own IP header. After the encapsulation by the XFRM layer, the packet goes through the Internet Layer again (e.g., the router layer).

In large systems when a large number of packets arrive and/or leave the first computing device, the central processing unit (CPU) that is hosting the operating system kernel can get bogged down since the encryption/decryption is very computing intensive. It is often desirable in such systems to have an offloaded encryption module to perform the encryption/decryption. However, these encryption/decryption functions are typically only available on specialized network processor hardware which are not in the kernel's packet processing path. Therefore, using such network processor hardware often requires modifying the kernel (e.g., to insert an asynchronous processing method or find other alternate methods to use these network processors).

Further, most OS encryption frameworks are architected assuming a tight-coupling between the main processor running the operating system and any external encryption hardware (e.g., a direct coupling, such as where the main processor and encryption hardware reside in the same computing device, and the main processor is in direct communication with the external encryption hardware). A tightly-coupled design is, for example, a design where the external encryption hardware (e.g., a network processor) is a co-processor to the main processor, such that the main processor can easily transmit a packet to the external encryption hardware and then subsequently receive the processed (e.g., encrypted/decrypted) packet back to continue processing the packet. When an operating system is configured (e.g., via an API) to use a tightly-coupled encryption module to perform actual encryption, the IP contents and/or IP header of the packet are encrypted by the encryption module (in either a synchronous or asynchonous manner). The operating system then performs additional Link Layer processing to the encrypted packet and only then does the OS forward the encrypted packet (from the kernel driver) to the network.

This tight-coupling of available software/hardware combinations is not suitable for all applications. For example, one organization often seen in security applications is the bump-in-the-wire (BITW) method, where the extra functionality of the encrypt/decrypt happens while the packets are passing on the wire, without involvement of the direct IP sender node or IP recipient node of the packets. The BITW method can be a useful approach when, for example, the network stack cannot be modified or when the hardware capable of the encrypt/decrypt is not directly coupled to the main processor but rather is located at a second processor that is in the path between the main processor and the network (i.e., loosely-coupled). However, use of BITW hardware architectures often requires offloading all IPsec functionality from the OS on the main processor to the offboard security processor located in the path to the network. For IPsec, for example, the second computing device can perform all the encryption processing including the SAD/SPD lookup, the encrypt, and then the link processing. However, offloading all encryption functionality (e.g., IPsec) from the OS does not take advantage of the rich and powerful framework for the negotiation and use of security associations built into many OSs.

### SUMMARY OF THE INVENTION

Rather than being tightly-coupled, an encryption module can be executed by a second computing device (e.g., encryption hardware) that is loosely-coupled to the operating system (e.g., is merely in the “path” between the first computing device and the network). However, with a loosely-coupled design, the path that crosses the boundary between the first computing device and the second computing device is often inefficient and/or unidirectional. Therefore, the operating system cannot use the loosely-coupled encryption module to perform the encryption since once the packet leaves the operating system, the data packet cannot be efficiently returned to the operating system.

To avoid the delay associated with returning the packet to the operating system, the operating system can be configured to process the data packet through the IP layers to completion, and then “hand off” the packet to a second computing device which then directly performs both the encryption and link processing, and sends the packet onto the network. However, as described above, this does not utilize the rich functionality of the operating system's built in encryption features. It is desirable to directly use the encryption functionality of the operating system on the first computing device to perform everything but the encryption or decryption, and for the second computing device to perform the encryption, decryption and link-layer processing (with a single handoff of packets from the first computing device to the second computing device).

In one aspect, the invention features an encryption apparatus including a first computing device in communication with a second computing device. The first computing device includes an operating system configured to process a data packet through one or more internet protocol stack layers to generate a processed data packet to be transmitted to a remote computer. The operating system is configured to determine encryption information including one or more parameters for encrypting and decrypting data packets transmitted between the first computing device and the remote computer. The operating system is configured to execute a bypass encryption routine to generate an unencrypted data packet based on the processed data packet. The bypass encryption routine does not encrypt the processed data packet. The operating system is configured to transmit the unencrypted data packet to the second computing device. The first computing device includes a negotiation module in communication with the operating system and the second computing device configured to transmit a message including data indicative of the encryption information to the second computing device. The operating system is unaware of a security nature of the transmission. The second computing device includes an encryption module configured to encrypt the unencrypted data packet based on the message transmitted from the first computing device to generate an encrypted data packet.

In another aspect, the invention features a computerized encryption method including processing, by a first computing device, a data packet through one or more internet protocol stack layers to generate a processed data packet to be transmitted to a remote computer. The method includes determining, by the first computing device, encryption information including one or more parameters for encrypting and decrypting data packets transmitted between the first computing device and the remote computer. The method includes transmitting, by the first computing device, a message including data indicative of the encryption information to a second computing device. An operating system being executed by the first computing device is unaware of a security nature of the transmission. The method includes executing, by the first computing device, a bypass encryption routine to generate a unencrypted data packet. The bypass encryption routine does not encrypt the processed data packet. The method includes transmitting, by the first computing device, the unencrypted data packet to the second computing device. The method includes encrypting, by the second computing device, the unencrypted data packet based on the message transmitted from the first computing device to generate an encrypted data packet.

In yet another aspect, the invention features a computerized decryption method executed by a decryption apparatus including a first computing device and a second computing device. The method includes receiving, by the second computing device, an encrypted data packet from a remote computer to the first computing device. The method includes determining, by the second computing device, encryption information including one or more parameters for encrypting and decrypting data packets transmitted between the first computing device and the remote computer. The method includes decrypting, by the second computing device, the encrypted data packet based on the encryption information to generate an unencrypted data packet. The method includes transmitting, by the second computing device, the unencrypted data packet to the first computing device. The method includes executing, by the first computing device, a bypass decryption routine to generate a processed data packet. The bypass decryption routine does not modify the unencrypted data packet. The method includes processing, by the first computing device, the processed data packet through one or more internet protocol stack layers to generate a data packet.

In yet another aspect, the invention features a decryption apparatus including a first computing device in communication with a second computing device. The second computing device is configured to receive an encrypted data packet from a remote computer to a first computing device. The second computing device is configured to determine encryption information including one or more parameters for encrypting and decrypting data packets transmitted between the first computing device and the remote computer. The second computing device is configured to decrypt the encrypted data packet based on the encryption information to generate an unencrypted data packet. The second computing device is configured to transmit the unencrypted data packet to the first computing device. The first computing device includes an operating system configured to execute a bypass decryption routine to generate a processed data packet. The bypass decryption routine does not modify the unencrypted data packet. The first computing device is configured to process the processed data packet through one or more internet protocol stack layers to generate a data packet.

In yet another aspect, the invention features an encryption apparatus. The encryption apparatus includes a first computing device in communication with a second computing device. The first computing device includes an operating system configured to processes a data packet through one or more internet protocol stack layers to generate a processed data packet to be transmitted to a remote computer. The operating system is configured to determine modified encryption information that does not include a desired security policy for the data packet. The modified encryption information includes one or more null parameters, and the modified encryption information is based on encryption information that includes the desired security policy. The encryption information includes one or more parameters for encrypting and decrypting data packets transmitted between the first computing device and the remote computer. The operating system is configured to execute a null-encryption routine to generate an unencrypted data packet based on the processed data packet and the modified encryption information. The null-encryption routine does not encrypt the processed data packet. The operating system is configured to transmit the unencrypted data packet to the second computing device. The first computing device includes a negotiation module in communication with the operating system and the second computing device configured to transmit a message including data indicative of the encryption information to the second computing device. The operating system is unaware of a security nature of the transmission. The second computing device includes an encryption module configured to encrypt the unencrypted data packet based on the message transmitted from the negotiation module to generate an encrypted data packet.

In yet another aspect, the invention features a computerized encryption method. The method includes processing, by a first computing device, a data packet through one or more internet protocol stack layers to generate a processed data packet to be transmitted to a remote computer. The method includes determining, by the first computing device, modified encryption information that does not include a desired security policy for the data packet. The modified encryption information includes one or more null parameters, and the modified encryption information is based on encryption information that includes the desired security policy. The encryption information includes one or more parameters for encrypting and decrypting data packets transmitted between the first computing device and the remote computer. The method includes transmitting, by the first computing device, a message including data indicative of the encryption information to a second computing device. An operating system being executed by the first computing device is unaware of a security nature of the transmission. The method includes executing, by the first computing device, a null-encryption routine to generate an unencrypted data packet based on the processed data packet and the modified encryption information. The null-encryption routine does not encrypt the processed data packet. The method includes transmitting, by the first computing device, the unencrypted data packet to the second computing device. The method includes encrypting, by the second computing device, the unencrypted data packet based on the message transmitted from the first computing device to generate an encrypted data packet.

In yet another aspect, the invention features a computerized decryption method executed by a decryption apparatus including a first computing device and a second computing device. The method includes receiving, by the second computing device, an encrypted data packet transmitted from a remote computer to the first computing device. The method includes determining, by the second computing device, encryption information that includes a desired security policy for the encrypted data packet. The encryption information includes one or more parameters for encrypting and decrypting data packets transmitted between the first computing device and the remote computer. The method includes decrypting, by the second computing device, the encrypted data packet based on the encryption information to generate an unencrypted data packet. The method includes transmitting, by the second computing device, the unencrypted data packet to the first computing device. The method includes determining, by the first computing device, modified encryption information that does not include the desired security policy. The modified encryption information includes one or more null parameters. The method includes executing, by the first computing device, a null-encryption routine. The null-encryption routine does not modify the unencrypted data packet. The method includes processing, by the first computing device, the unencrypted data packet through one or more internet protocol stack layers to generate a data packet.

In yet another aspect, the invention features a decryption apparatus including a first computing device in communication with a second computing device. The second computing device is configured to receive an encrypted data packet transmitted from a remote computer to a first computing device. The second computing device is configured to determine encryption information that includes a desired security policy for the encrypted data packet. The encryption information includes one or more parameters for encrypting and decrypting data packets transmitted between the first computing device and the remote computer. The second computing device is configured to decrypt the encrypted data packet based on the encryption information to generate an unencrypted data packet. The second computing device is configured to transmit the unencrypted data packet to the first computing device. The first computing device includes an operating system configured to determine modified encryption information that does not include the desired security policy. The modified encryption information includes one or more null parameters. The first computing device is configured to execute a null-encryption routine. The null-encryption routine does not modify the unencrypted data packet. The second computing device is configured to process the unencrypted data packet through one or more internet protocol stack layers to generate a data packet.

In other embodiments, any of the aspects above, or any apparatus, device or system or method, process or technique described herein, can include one or more of the following features.

In various embodiments, the second computing device is further configured to transmit the encrypted data packet to the remote computer. The negotiation module can be configured to generate the encryption information, transmit the encryption information to the operating system through a socket, and transmit the message including data indicative of the encryption information to the second computing device. The negotiation module can include an unmodified key management application and a snoop application configured to monitor the socket to generate the message, or a modified key management application.

In one or more embodiments, a database is in communication with the first computing device, and determining the encryption information includes retrieving the encryption information from the database. The first computing device can include a bypass encryption module in communication with the operating system configured to receive the processed data packet from the operating system, execute the bypass encryption routine to generate the unencrypted data packet, and transmit the unencrypted data packet to the operating system. The encryption module can be configured to add one or more padding bytes to the processed data packet to generate the unencrypted data packet.

In one or more embodiments, the first computing device is a main processor and the second computing device is a network processor. The operating system can be Linux and the operating system can include an IPsec implementation.

In one or more embodiments, the bypass encryption routine includes a user-specified bypass encryption routine that is separate from the operating system and does not require modification of the operating system to install the bypass encryption routine. The operating system processes the unencrypted data packet as if the unencrypted data packet were an encrypted data packet. The second computing device can transmit the encrypted data packet to the remote computer.

In one or more embodiments, determining the encryption information includes determining whether a security association between the first computing device and the remote computer is stored in a database. If a security association for the first computing device and the remote computer is not stored in the database, a security association can be determined for the first computing device and the remote computer. A key management application can be modified to transmit the message including data indicative of the encryption information to the second computing device.

In one or more embodiments, a request for encryption information is transmitted between the first computing device and the remote computer to an unmodified key management application using a socket, and data indicative of the encryption information for the first computing device and the remote computer using the socket is received from the unmodified key management application. A snoop application can monitor the socket to determine the message including data indicative of the encryption information. Executing the bypass encryption routine can include adding one or more padding bytes to the processed data packet to generate the unencrypted data packet.

In one or more embodiments, the unencrypted data packet includes original plaintext from the data packet. Executing the bypass encryption routine can include transmitting, by an operating system, the processed data packet to the bypass encryption routine through an application programming interface. The bypass encryption routine is registered with the operating system. The operating system receives the unencrypted data packet from the bypass encryption routine. The operating system processes the unencrypted data packet as if the unencrypted data packet were an encrypted data packet.

In one or more embodiments, the operating system is configured to transmit a request for the encryption information to a modified key management application, and receive the modified encryption information from the modified key management application. The negotiation module can include the modified key management application. The modified key management application is configured to receive the request from the operating system, calculate the encryption information, transmit the modified encryption information to the operating system, and transmit the encryption information to the second computing device. The modified key management application can be configured to receive the encryption information from the key management application, calculate the modified encryption information, transmit the modified encryption information to the key management application, and transmit the encryption information to the second computing device. The request for the encryption information can include a request for an advanced encryption standard policy, and the encryption information includes an advanced encryption standard policy.

In one or more embodiments, the second computing device is configured to transmit the encrypted data packet to the remote computer. The first computing device can be a main processor and the second computing device is a network processor. The operating system can be Linux and the operating system can include an IPSec implementation.

In one or more embodiments, a request to calculate the encryption information is received, the encryption information is calculated in response to the request, and the modified encryption information is calculated based on the encryption information including calculating the one or more null parameters, including a null encryption parameter and a null authentication parameter. Calculating the encryption information can include calculating a security association between the first computing device and the remote computer. The security association includes a security parameter index and one or more encryption parameter. The security association is stored in a database.

In one or more embodiments, the second computing device transmits the encrypted data packet to the remote computer. The encryption information is stored in a database in communication with the second computing device. Encrypting the unencrypted data packet based on the encryption information includes identifying the security association based on a supplied context identifier, a packet header for the unencrypted data packet, or both. The unencrypted data packet can include original plaintext from the data packet. Determining the modified encryption information can include retrieving the modified encryption information from a database in communication with the first computing device.

In one or more embodiments, the operating system is configured to receive data indicative of a fragmentation configuration parameter calculated based on the encryption information. The operating system can fragment the unencrypted data packet based on the fragmentation configuration parameter.

The techniques, which include both methods and apparatuses, described herein can provide one or more of the following advantages. Encryption (e.g., IPsec encryption/decryption) can be supported using a generally-available operating system with a loosely-coupled network processor (e.g., a processor configured to perform the actual encryption/decryption). An operating system can be loosely-coupled to the network processor without requiring any changes to the operating system. The operating system can be faked to not encrypt a processed data packet (e.g., an unmodified operating system can be configured to execute a bypass encryption routine that does not encrypt the processed data packet, yet the operating system processes the packet returned from the bypass encryption routine as if it were encrypted). By performing the “fake”, the rich and powerful framework for the negotiation and use of IPsec security associations built into many OS's can be utilized while still offloading the encrypt/decrypt operations to a loosely-coupled offboard security processor. The normal requirement for the security processor to return an encrypted packet to the operating system for continued processing can be eliminated (e.g., the main processor transmits the data message to the network processor, and the network processor encrypts the data packet and transmits the encrypted data packet to the remote computer without transmitting the encrypted data packet back to the main processor for any further processing).

Other aspects and advantages of the invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the invention, as well as the invention itself, will be more fully understood from the following description of various embodiments, when read together with the accompanying drawings.

FIG. 1 illustrates an architectural diagram of a switch for loosely-coupled encryption functionality for an operating system.

FIG. 2 illustrates an architectural diagram of an operating system being faked to not encrypt a processed data packet according to a first embodiment.

FIG. 3 illustrates an architectural diagram of a switch that includes loosely-coupled encryption functionality for an operating system according to a first embodiment using an unmodified key management application and a snoop application.

FIG. 4 illustrates an architectural diagram of a switch that includes loosely-coupled encryption functionality for an operating system according to a first embodiment using a modified key management application.

FIG. 5 is a method for encrypting a data packet using loosely-coupled encryption functionality according to a first embodiment.

FIG. 6A is a detailed method for determining encryption information using loosely-coupled encryption functionality according to a first embodiment.

FIG. 6B is a detailed method for presenting an encryption façade using loosely-coupled encryption functionality according to a first embodiment.

FIG. 7 is a method for decrypting a data packet using loosely-coupled encryption functionality according to a first embodiment.

FIG. 8 illustrates an architectural diagram of an operating system being faked to not encrypt a processed data packet according to a second embodiment.

FIG. 9 illustrates an architectural diagram of a switch that incorporates loosely-coupled encryption functionality for an operating system according to a second embodiment using a modified key management application.

FIG. 10 is a method for encrypting a data packet using loosely-coupled encryption functionality according to a second embodiment.

FIG. 11 is a method for calculating modified encryption information using loosely-coupled encryption functionality according to a second embodiment.

FIG. 12 is a method for decrypting a data packet using loosely-coupled encryption functionality according to a second embodiment.

### DETAILED DESCRIPTION

In general overview, an operating system is faked into not encrypting/decrypting a data packet while still performing the remaining encryption/decryption processing functionality to the data packet. The actual encryption/decryption is performed by a loosely-coupled computing device (e.g., network processor). Although many of the examples in the specification and/or figures describe the techniques in terms of Linux and IPsec, these techniques work equally as well on any operating system with an encryption/decryption protocol (or suite), such as an operating system that supports a driver API for a user-specified encrypt/decrypt or an operating system that supports null-encryption. It should be understood that the term encryption used herein can be used to refer to both encryption and decryption, and does not refer to just encryption (e.g., an encryption module can both encrypt and decrypt data).

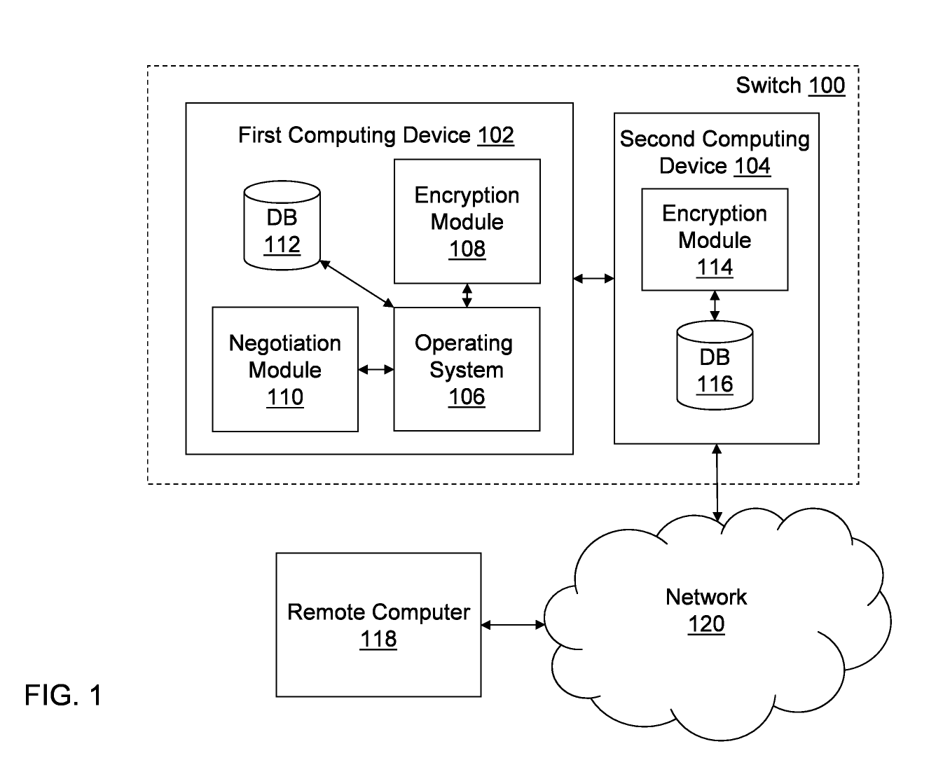

FIG. 1 illustrates an architectural diagram of a switch 100 for loosely-coupled encryption functionality for an operating system. The switch 100 includes a first computing device 102 in communication with a second computing device 104. The first computing device 102 includes an operating system 106, which is in communication with an encryption module 108, a negotiation module 110, and a database 112. The second computing device 104 includes an encryption module 114. The encryption module 114 is in communication with a database 116. The second computing device 104 is in communication with one or more remote computers 118 via a network 120.

The first computing device can be a main processor (e.g., running the operating system 106, such as Linux) and the second computing device can be a network processor (e.g., running proprietary code). Logically, for example, the first computing device 102 and the second computing device 104 can be two separate processor systems connected by an internal bus within the switch 100. The operating system 106 can be any software program that provides an interface between the hardware of the first computing device 102 and other software. Examples of operating systems include Mac OS X, the Microsoft Windows family of operating systems, Linux, Unix-like operating systems, etc. In one embodiment, the operating system 106 is a Linux 2.6 OS with an IPsec implementation (framework).

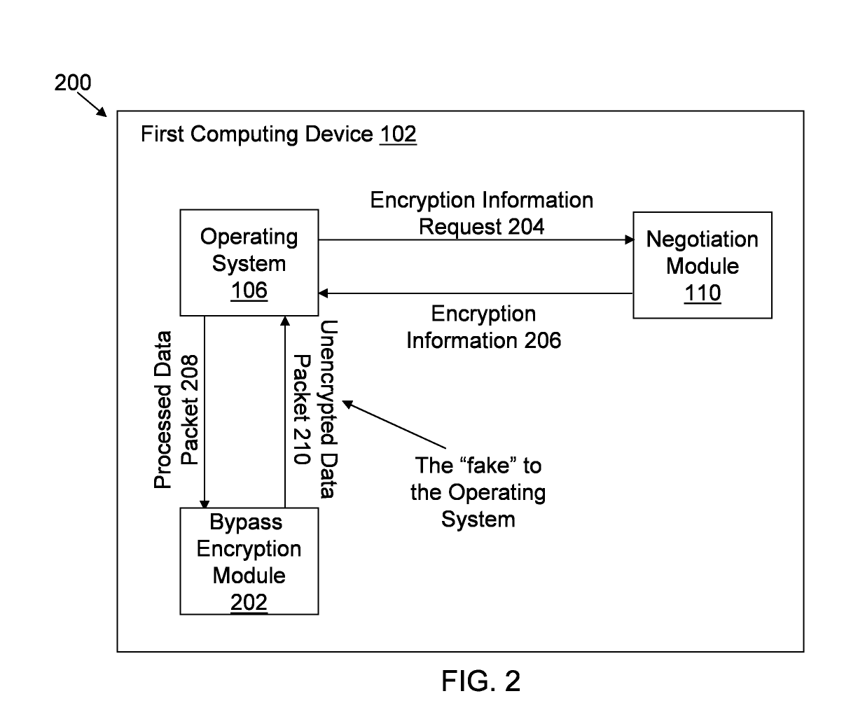

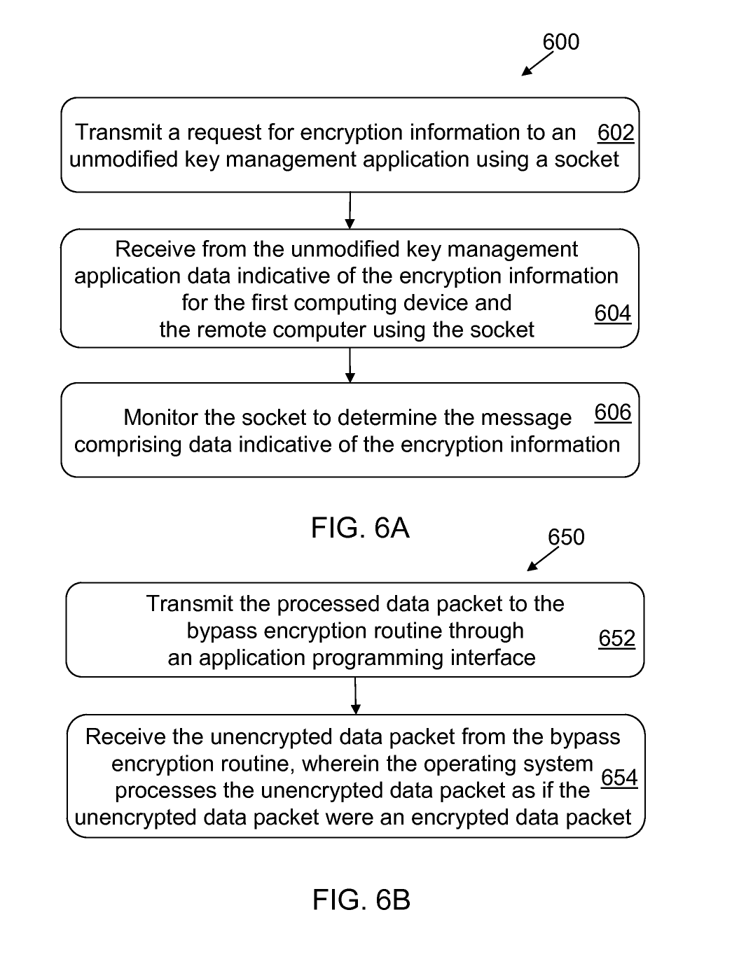

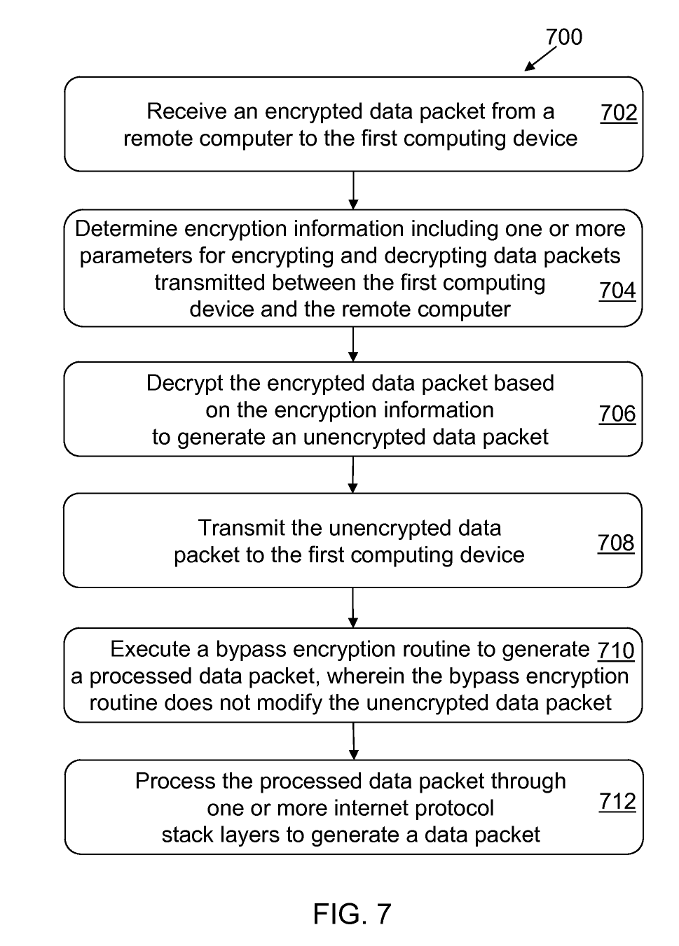

The operating system 106 includes an interface (e.g., an API interface) to the encryption module 108. The encryption module 108 can be a user-supplied encryption/decryption module. The encryption module 108 can be, for example, a bypass encryption module (e.g., as described in FIGS. 2-4) or a null encryption module (e.g., as described in FIGS. 6-7). For example, the interface can be a scatter/gather interface allowing the operating system 106 (the kernel) to request the encryption module 108 to encrypt/decrypt a discontiguous set of memory buffers (or pages).

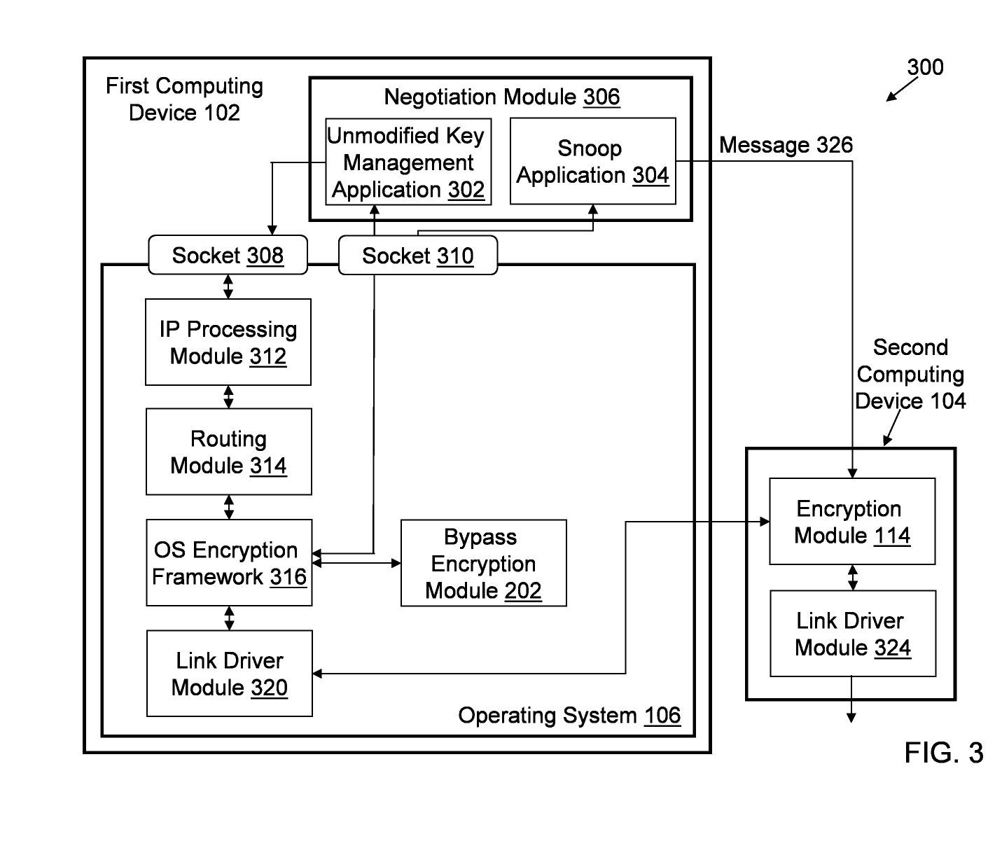

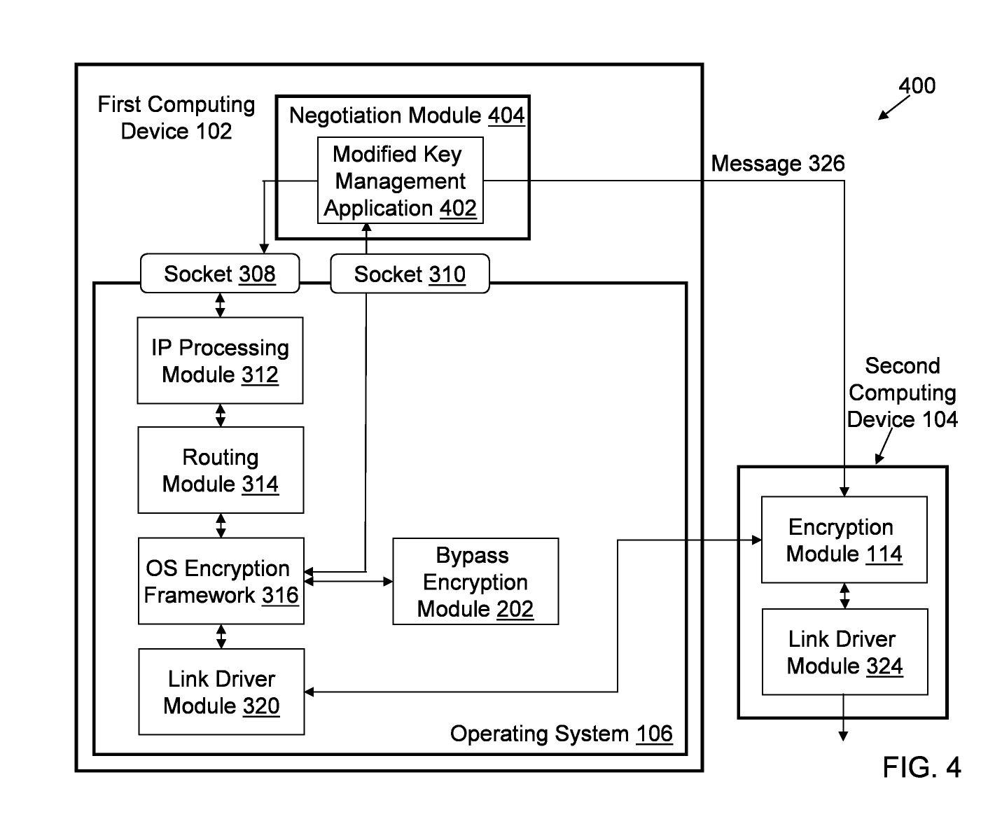

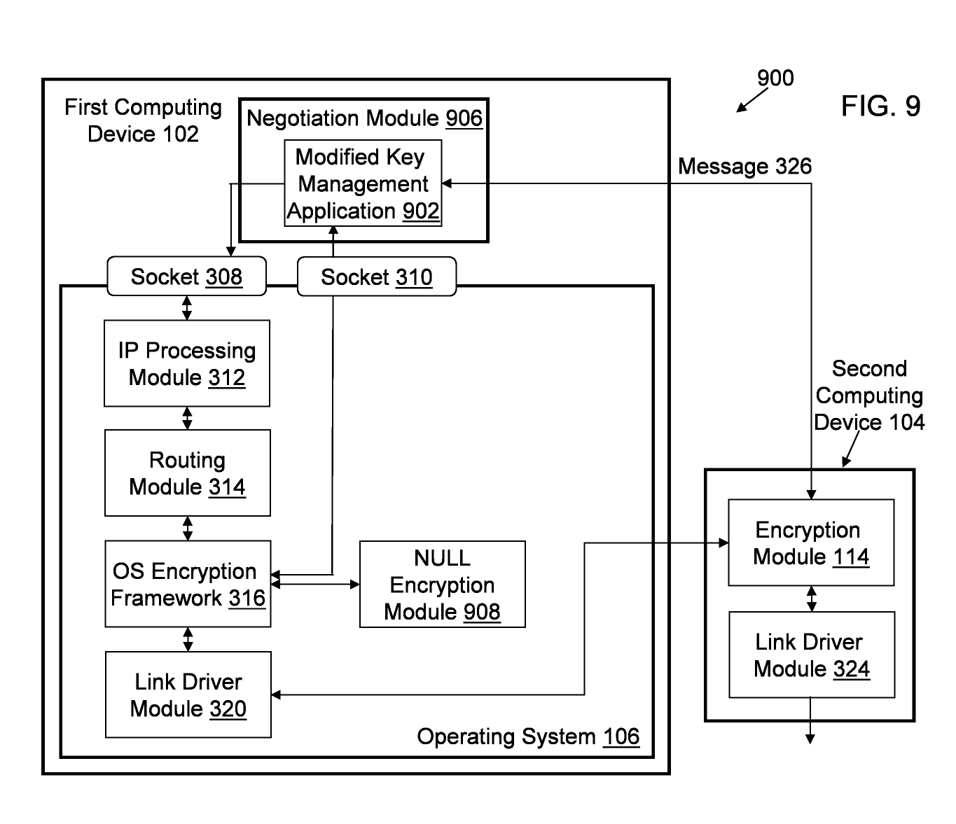

The negotiation module 110 is a key management application configured to negotiate encryption information (e.g., security association (SA) information) between the switch 100 and the remote computer 118. The negotiation module 110 also conveys encryption information to the operating system 106 and the second computing device 104. The negotiation module 110 can include, for example, an unmodified key management application and a snoop application (e.g., as described in FIG. 3), a modified key management application (e.g., as described in FIG. 4 or FIG. 9). The databases 112 and 116 are configured to store data, including encryption information, for data streams transmitted between the switch 100 and the remote computer 118 (e.g., the SAD, SPD, etc.). While only one remote computer 118 is shown for simplification purposes, the switch 100 can be in communication with any number of remote computers.

The switch 100 can be an interconnect switch. For example, the switch 100 can handle IP-to-IP interconnect for IP-voice peering and access, providing security, control, and Service Level Agreement (SLA) services. The switch 100 can be, for example, the NBS® Network Border Switch available from Sonus Networks, Inc.

FIG. 2 illustrates an architectural diagram 200 of the operating system 106 from FIG. 1 being faked to not encrypt a processed data packet according to a first embodiment. The operating system 106 is in communication with the negotiation module 110 and the bypass encryption module 202. The operating system 106 sends an encryption information request 204 (e.g., key negotiation request) to the negotiation module 110. The negotiation module sends encryption information 206 (e.g., SA info) to the operating system 106. The operating system 106, using the encryption information 206, sends the processed data packet 208 (e.g., via a scatter/gather API) to the bypass encryption module 202. The bypass encryption module 202 executes a bypass encryption routine to generate an unencrypted data packet 210. The bypass encryption module 202 transmits the unencrypted data packet 210 to the operating system 106.

The operating system 106 is faked into processing the unencrypted data packet 210 as if the unencrypted data packet 210 were an encrypted data packet. The bypass encryption module 202 is registered as an encryption module with the operating system 106. The operating system 106 allows user-supplied implementations of encryption modules. Each such software encryption module provides interface functions for various cryptographic operations (such as encrypt, decrypt, etc), and it registers itself for particular cryptographic protocols (such as 3DES, AES, etc). With such a registration in place, when the operating system 106 needs the specific cryptographic operation, the operating system 106 invokes the supplied encryption module (e.g., bypass encryption module) to perform the operation.

When invoked, the bypass encryption module 202 executes a user-specified bypass encryption routine. The bypass encrypt routine is, for example, separate from the operating system 106 and does not require modification of the operating system 106 to install. The bypass encryption module 202 is configured to interface with the operating system 106 as if it were a true encryption module. For example, the bypass encryption module 202 advertises to the operating system 106 capabilities for encryption of all the relevant cryptographic algorithms. However, the bypass encryption module 202 does not actually implement an encryption algorithm (i.e., it doesn't encrypt or decrypt, and therefore presents a façade to the operating system 106 by telling the operating system 106 that it is actually performing AES encryption). For example, the bypass encryption module 202 does not encrypt the IP data or IP headers of the processed data packet 208, and the resulting packet is the plaintext of the data packet. While the data in the unencrypted data packet 210 is plaintext, the bypass encryption module 202 can be configured to perform some processing to the processed data packet 208 (e.g., which can distinguish the bypass encryption module 202 from purely a null encryption routine). For example, the bypass encryption module 202 can be configured to add one or more padding bytes to the processed data packet 208 to generate the unencrypted data packet 210 (e.g., AES requires 256 bytes, so even if the bypass encryption module does not encrypt the data, padding bytes can be added to achieve the requisite 256 bytes).

Advantageously, the operating system 106 processes the unencrypted data packet 210 (e.g., via the XFRM layer) using all of the built-in encryption functionality (e.g., IPsec), but without actually encrypting/decrypting the data. The encrypt/decrypt can later be performed by encryption hardware or software (e.g., via the second computing device 104) both without transmitting the encrypted data packet back to the first computing device 102 and without bypassing the built-in security functionality (e.g., all the non-encryption/decryption related functionality, such as SA negotiation, SAD functionality, SPD functionality, etc.) of the operating system 106. To the operating system 106, or the negotiation module 110 (e.g., a key management application), there appears to be no differences from a standard OS flow (e.g., a Linux IPsec flow), and the operating system 106 processes the data packet as if the encrypt/decrypt is being handled by the invoked bypass encryption module 202 (e.g., from the XFRM layer). This unchanged view from the operating system 106 and negotiation module 110 can allow the switch to perform the actual encryption/decryption by a loosely-coupled computing device (e.g., the second computing device 104 of FIG. 3) without requiring any changes to operating system kernel 106 core or the negotiation module 110.

FIG. 3 illustrates an architectural diagram of a switch 300 that includes loosely-coupled encryption functionality for the operating system 106 according to a first embodiment, using an unmodified key management application 302 (e.g., Racoon2 or any other key management application) and a snoop application 304. The switch 300 includes the first computing device 102 in communication with the second computing device 104. The first computing device 102 includes the operating system 106, which is in communication with the negotiation module 306 through sockets 308 and 310. The operating system 106 receives packets (e.g., for transmission to remote computers) from one or more user-space applications (not shown) through socket 308 (e.g., an INET or INET6 socket). Socket 310 is, for example, a kernel interface or user interface (e.g., PF_KEY socket) from the kernel space of the operating system 106 to the user space of the first computing device 102.

The negotiation module 306 (e.g., the negotiation module 110 of FIG. 1) includes the unmodified key management application 302 and a snoop application 304. The unmodified key management application 302 exchanges key-negotiation messages with the receiving remote computers through the socket 308. The unmodified key management application 302 is configured to send encryption information (e.g., SA update messaging) to the operating system 106 through socket 310. The snoop application 304 is configured to listen to socket 310 to glean information communicated between the unmodified key management application 302 and the operating system 106 via socket 310. For example, the snoop application 304 can be registered in promiscuous mode to listen to socket 310. The snoop application 304 is configured to transmit a message 326 (e.g., SA info) to the encryption module 114 of the second computing device 104 based on the data gleaned from socket 310.

The operating system 106 includes IP processing module 312, which is in communication with the socket 308 and the routing module 314. The IP processing module 312 and the routing module 314 comprise, for example, the Internet Layer of the IP protocol stack. The routing module 314 is in communication with the OS encryption framework 316 (e.g., the XFRM framework of the Linux OS or any other encryption framework). The OS encryption framework 316 is in communication with the unmodified key management application 302 of the negotiation module 306 via socket 310. For example, the OS encryption framework 316 can send key negotiation requests to the registered unmodified key management application 302 (e.g., ACQUIRE and other PF_KEY messaging) and receive SA information from the unmodified key management application 302 via socket 310. The OS encryption framework 316 is also in communication with the bypass encryption module 202 of FIG. 2 and the link driver module 320. The link driver module 320 is, for example, the Link Layer of the IP protocol stack.

The second computing device 104 includes an encryption module 114 which is in communication with a link driver module 324. The link driver module 324 is in communication with one or more remote computers (not shown, e.g., via the internet). The encryption module 114 of the second computing device 104 is configured to receive the message 326 from the snoop application 304.

Referring to FIG. 2, the bypass encryption module 202 does not produce an encrypted data packet, but instead returns the unencrypted data packet 210 to the operating system 106. However, the encryption module 114 is configured to perform encryption of the unencrypted data packet 210. The link driver module 320 transmits the unencrypted data packet 210 to the encryption module 114. The encryption module 114, using the encryption information gleaned from message 326, encrypts the unencrypted data packet. Therefore, the overall switch 300 produces an encrypted data packet (and therefore an encrypted data stream).

FIG. 4 illustrates an architectural diagram of a switch 400 that incorporates loosely-coupled encryption functionality for an operating system according to a first embodiment using a modified key management application 402. Similar to FIG. 3, the switch 400 includes the first computing device 102 in communication with the second computing device 104. The first computing device 102 includes the operating system 106 which is in communication with the negotiation module 404 through sockets 308 and 310. The operating system 106 includes IP processing module 312, which is in communication with the socket 308 and the routing module 314. The routing module 314 is in communication with the OS encryption framework 316. The OS encryption framework 316 is in communication with the modified key management application 402 of the negotiation module 404 via socket 310. The OS encryption framework 316 is also in communication with the bypass encryption module 202 and the link driver module 320. The second computing device 104 includes encryption module 114 which is in communication with a link driver module 324.

In this embodiment, the negotiation module 404 does not include a snoop application (e.g., like the negotiation module 306 of FIG. 3). Instead, the negotiation module 404 includes a modified key management application 402 that is modified to transmit the message 326 to the encryption module 114 of the second computing device 104. The key management application 402 is still configured to perform the key management functionality (e.g., the modified key management application 402 is a modified Racoon2 implementation). Advantageously, the snoop application functionality can be configured into the modified key management application 402 to, for example, avoid registering a snoop application in promiscuous mode (e.g., which requires being a root process on the first computing device 102).

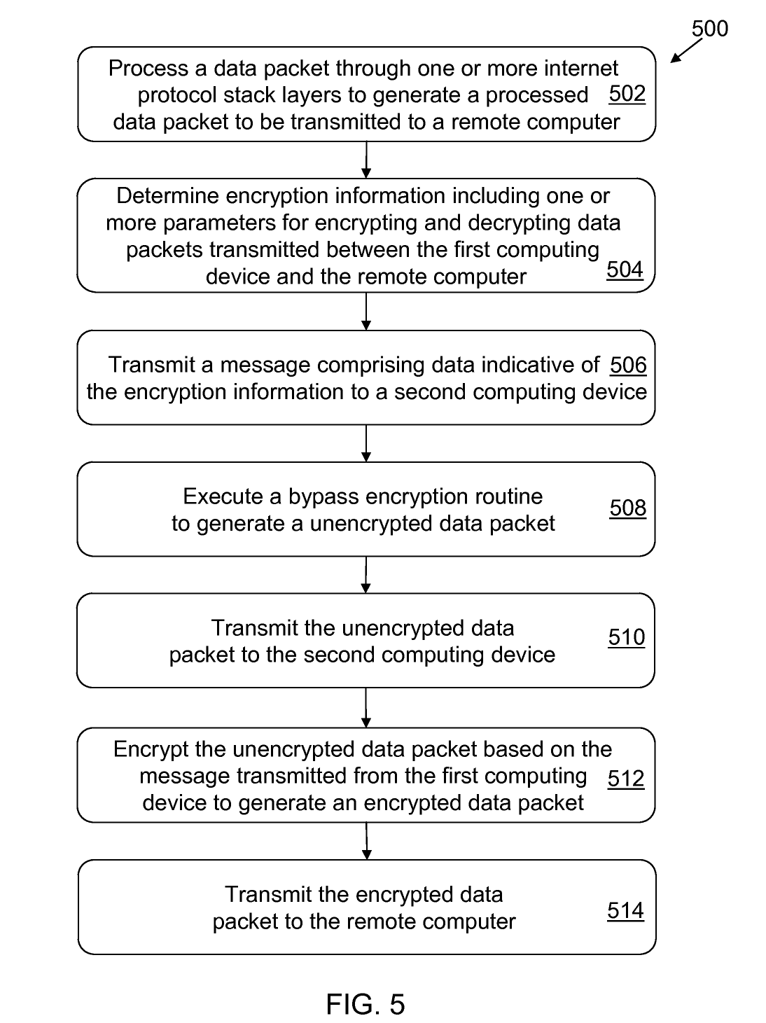

FIG. 5 is a method 500 (a computerized method) for encrypting a data packet using loosely-coupled encryption functionality according to a first embodiment. Referring to FIGS. 3 and 4, at step 502 the operating system 106 processes a data packet through one or more internet protocol stack layers (e.g., via the IP processing module 312 and the routing module 314) to generate a processed data packet to be transmitted to a remote computer (e.g., the remote computer 118 of FIG. 1). At step 504, the operating system 306 determines encryption information including one or more parameters for encrypting and decrypting data packets transmitted between the first computing device 102 and the remote computer. At step 506, the negotiation module (e.g., the snoop application 304 in negotiation module 306 of FIG. 3 or the modified key management application 402 in the negotiation module 404 of FIG. 4) transmits message 326, comprising data indicative of the encryption information to the second computing device 104 (to the encryption module 114). At step 508, the operating system 106 executes a bypass encryption routine (via bypass encryption module 202) to generate a unencrypted data packet. The bypass encryption routine does not encrypt the processed data packet.

At step 510, the link driver module 320 transmits the unencrypted data packet to the second computing device 104. At step 512, the encryption module 114 encrypts the unencrypted data packet based on the message 326 transmitted from the first computing device 102 to generate an encrypted data packet. At step 514, the encryption module 114 transmits the encrypted data packet to the link driver module 324, which transmits the encrypted data packet to the remote computer.

Referring to step 504, the operating system 106 can determine whether encryption information (an SA) between the first computing device 102 and the remote computer is stored in a database of the first computing device 102 (e.g., database 112 of FIG. 1). For example, if a SA was previously negotiated (e.g., via the key management application in the negotiation module), then the operating system 106 can have a SA stored in the database, and the operating system 106 can retrieve the encryption information from the database. However, if encryption information is not stored in the database (e.g., if the data packet is the first packet of the transmission), the operating system 106 determines encryption information for the first computing device 102 and the remote computer.

Referring to step 506, the operating system 106 being executed by the first computing device 102 is unaware of a security nature of the transmission of message 326 to the second computing device 104. For example, the message 326 is transmitted from the negotiation module (e.g., a user-space application) to the second computing device 104 via a hardware device (e.g., a network processor card). While the operating system 106 may process the message 326 for transmission through the hardware device, the operating system 106 may not be aware of the security nature (e.g., that the message 326 includes encryption information) of the message 326. For example, the OS encryption framework 316 did not initiate the transmission of message 326 to the second computing device 104 (e.g., the OS encryption framework 316 is unaware of the transmission of message 326 by the negotiation module).

FIG. 6A is a detailed method 600 for determining encryption information using loosely-coupled encryption functionality according to a first embodiment. Referring to FIGS. 2-4, at step 602, if the OS encryption framework 316 does not have encryption information, the OS encryption framework 316 transmits a request for encryption information between the first computing device 102 and the remote computer to a key management application (e.g., either the unmodified key management application 302 or the modified key management application 402) using the socket 110. At step 604, the OS encryption framework 316 receives, from the key management application, data indicative of the encryption information for the first computing device 102 and the remote computer using the socket 110. At step 606, the negotiation module (e.g., via the snoop application 304 monitoring the socket 310 or the modified key management application 402) creates the message 326 comprising data indicative of the encryption information.

Referring to step 506, the negotiation module transmits the message 326 to the second computing device 104. In some embodiments, the snoop application 304 transmits the message 326. In other embodiments, the key management application is modified to transmit the message 326. The message 326 comprises all information needed to perform encryption/decryption. For example, the message 326 includes the peer address, encryption key, an encryption cipher, encryption key length, and all other information required to perform encryption/decryption. The negotiation module also transmits the encryption information to the operating system 106 through socket 310.

Referring to step 508, as described above the bypass encryption module 202 presents a façade to the OS encryption framework 316 and does not actually encrypt the processed data packet. FIG. 6B is a detailed method 650 for presenting an encryption façade using loosely-coupled encryption functionality according to a first embodiment. At step 652 the OS encryption framework 316 transmits the processed data packet to the bypass encryption routine 202 (executing the bypass encryption routine) through an API (e.g., a function-call API). The bypass encryption module 202 is registered as an encryption module with the operating system 106. The OS encryption framework 316 receives the unencrypted data packet from the bypass encryption module 202. The operating system 106 processes the unencrypted data packet as if the unencrypted data packet were an encrypted data packet. For example, the OS encryption framework 316 completes processing the unencrypted data packet and transmits it to the link driver module 320 for transmission (e.g., to the second computing device 104).

Referring to step 512, the encryption module 114 encrypts the unencrypted data packet to generate the unencrypted data packet (e.g., as 3DES, AES, etc.).

An example of the encryption method 500 is provided below, which is intended to be illustrative of the concepts described herein and not limiting in any manner. Many of the details provided in the example are particular to the embodiments being described therein, but one should appreciate that the concepts apply in other configurations and environments. In particular, the concepts described herein apply to any operating system which allows for user-supplied software encryption modules. A modified key management application, a snoop application, or some other means can glean the SA information (the encryption information) generated from the key management application and convey the SA information to the second computing device 104.

For this example, the operating system 106 is a Linux 2.6 kernel (the OS encryption framework 316 is the XFRM framework), and the first computing device 102 is a standard main processor system. The second computing device 104 is a network processor system including an encryption module 114 configured to encrypt/decrypt a packet using the AES cipher. The key management application (e.g., the unmodified key management application 302 in FIG. 3 or the modified key management application 402 in FIG. 4) can be any IPsec Key Exchange (IKE) implementation (e.g., IKE defined by RFC 2309 or IKEv2 defined by RFC 4306) that interfaces with the operating system kernel 106 through socket 310 interface (e.g., a PF_KEY socket as defined by RFC 2367). This example uses Racoon2 (available from the TheRacoon2Project). The bypass encryption module 202 provides an AES cipher façade (since the encryption module 114 is using the AES cipher). The bypass encryption module 202 can be configured roughly analogous both in operation and form to the AES implementation typically found in the “kernel/crypto/” directory of the Linux 2.6 distribution. In particular, the bypass encryption module 202 is a loadable kernel module (LKM). The bypass encryption module 202 registers with the operating system 106 as an encryption algorithm with an appropriately completed crypt_alg structure in the LKM init routine. The bypass encryption module 202 provides an encrypt and decrypt routine, along with all the necessary crytographic parameters (e.g., such as keysize, etc.). The bypass encryption module 202 indicates that it is the highest preference for the AES algorithm (i.e. ahead of the built in implementation). The bypass encryption module 202 deregisters the algorithm in the LKM cleanup routine. Also, while the bypass encryption module 202 indicates that it handles the encrypt/decrypt for AES, the bypass encryption module 202 does not actually encrypt the data packet contents. Specifically, the encrypt and decrypt routines need not transform the input packet in any way. A plaintext packet given to the encrypt routine can come out in plaintext (with any additional processing, such as adding padding bytes, being performed), and an encrypted packet given to decrypt routine returns the same decrypted packet.

In this example, the snoop application 304 is configured to open a PF_KEY socket (socket 310) in promiscuous mode. The snoop application 304 runs as a root process, and therefore sees any PF_KEY interactions over socket 310 between the operating system 106 and the unmodified Racoon2 key management application 302. In particular, the snoop application 304 sees the SADB_ACQUIRE, SADB_GETSPI, SADP_UPDATE, and the other PF_KEY messaging between the operating system kernel 106 and Racoon2 key management application 302. The snoop application 304 has an interface (e.g., through an operating system kernel 106 driver) to the second computing device 104, the network interface system (NIS). This interface allows the snoop application 304 to notify the second computing device 104 (e.g., the encryption module 114) of important encryption information, such as SA information including the IPsec Security Parameter Index (SPI) and the cryptographic parameters associated with that SPI.

The link driver module 320 comprises a link level driver for the second computing device 104. The link driver module 320 can be, for example, a normal Linux link level driver which transfer packets between the Linux operating system kernel 106 and the second computing device 104 (the NIS). The specific type of driver model used can depend on the hardware specifics. For this example, the link driver module 320 can be configured as a driver for any high-speed network interface card.

The second computing device 104 provides both physical layer connectivity to the network (e.g., network 120) and hardware capable of encrypting a packet before sending it, or decrypting a packet after receiving it. Common examples of encryption hardware include commercial boards containing network-processors with on-board encryption/decryption algorithms (the encryption module 114) and coupled with Ethernet interfaces (the link driver module 324). The encryption module 114 runs code which can encrypt or decrypt the packets based on the cryptographic parameters associated with specific SPIs. Many implementations of encryption hardware/algorithms are capable of tremendous rates of encrypt and decrypt, often at full-wire speeds for all network ports on the card.

IPsec protection starts with the definition of security policy rules. An interface to the SPD allows a user to enter SPD rules. The interface can be, for example, a command-line interface provided by Linux, or a user application which invokes the relevant APIs for adding rules. Whatever the method, the SPD can be populated with user-specified rules. For the purpose of this example, assume that the user has entered a rule comprising at least the following parameters: LocalIP=10.10.10.10, RemoteIP=10.160.20.63, RemotePort=5060, LocalPort=* (e.g., a wildcard value that indicates any port can be used), and Algorithm=AES.

For this example, further assume that an application initiates a connection which matches the rule (e.g., an IP application transmits a first packet for a connection to IP 10.160.20.63 at port 5060 through the operating system 106 via socket 308). The processing in this example for the initial packet is next described. Referring to FIGS. 3 and 5, at step 502 the Linux operating system kernel 106 performs its normal Transport Layer and Internet Layer processing (e.g, via IP processing module 312, routing module 314, and other modules not shown) to generate the processed data packet. This processing includes, for example, transport layer header addition, IP header addition, and IP routing. The packet is given to the XFRM encryption framework 316.

Referring to step 504, the XFRM encryption framework 316 checks the packet parameters against the SPD (e.g., located in database 112 of FIG. 1). Since there is a matching rule, the XFRM encryption framework 316 attempts to find a matching SA entry in the SAD (e.g., also located in the database 112 of FIG. 1). No such entry is found in the SAD since this is the initial packet. The XFRM encryption framework 316 then queues the packet and sends an SADB_ACQUIRE message on the PF_KEY socket 310 to the registered Racoon2 unmodified key management application 302. The SADB_ACQUIRE message includes all the necessary cryptographic parameters including protocol (AES), IP addressing, port, protocol, etc. The Racoon2 unmodified key management application 302 receives the SADB_ACQUIRE message. The Racoon2 unmodified key management application 302 sends an SADB_GETSPI request to the operating system kernel 106 through socket 308. The operating system kernel 106 allocates a SPI and sends the response through the PF_KEY socket 310. The Racoon2 unmodified key management application 302 negotiates the encryption information—the SA parameters—with the IKE peer (of the receiving remote computer at IP 10.160.20.63). This is, for example, a normal IKE negotiation as defined in IETF 2409. Any key-negotiation application can be used as it's the outcome (the SA) the is useful to the switch, not the method or processes of negotiating the SA. The Racoon2 unmodified key management application 302 pushes the SA encryption information into the operating system kernel 106 through the PF_KEY socket 310 with an SADB_UPDATE message. The operating system kernel 106 creates the SA entry in the SAD (via the XFRM encryption framework 316).

Referring to step 506, the snoop application 304 sees the SADB_ACQUIRE message, the SADB_GETSPI request, and the response from the operating system kernel 106 (but need not act on these messages). The snoop application 304 also sees the SADB_UPDATE message and the SA contents. The snoop application 304 sends the SA information to the second computing device 104 via message 326 (e.g., using the relevant driver API). The encryption module 114 creates an SA entry in a local SAD (e.g., in the database 116). The XFRM encryption framework 316 dequeues the packets waiting on the SA.

Referring to step 508, the operating system kernel 106 locates the highest precedence encryption module for the AES protocol (which is the bypass encryption module 202, the pseudo-AES module), and invokes the bypass encryption module 202's encrypt algorithm with the keying information and the packet. The bypass encryption module 202 performs any necessary processing to the packet (such as padding, etc.) but does not alter the plaintext packet contents. The module returns success to the kernel indicating that it has “encrypted” the packet, generating the unencrypted data packet.

Referring to step 510, the XFRM encryption framework 316 passes the unencrypted data packet to the link driver module 320. The link driver module 320 performs typical link layer activities (such as adding the link layer header) and transmits the unencrypted data packet to the second computing device 104 (the NIS). Referring to step 512, the encryption module 114 extracts the SPI, target address, and security protocol from the unencrypted data packet and checks for a matching SA entry in the local SAD. This check can find the SA previously added by the snoop application 304 (e.g., via step 506). The encryption module 114 encrypts the packet in place using the keying information from the SA to generate the truly encrypted data packet. Referring to step 512, the encryption module 114 then passes the encrypted data packet to the link driver module 324. The link driver module 324 performs any additional link processing (such as computing the CRC32 on the final encrypted data packet contents) and then forwards the encrypted data packet onto the network.

The embodiment described above used the snoop application 304 to generate the message 326, which usually requires a root process to install it in promiscuous mode. In an alternative embodiment as shown in FIG. 4, the key management application 402 itself can be modified to (in addition to negotiating the SAs) push the SA information into the encryption module 114. Advantageously, the modified key management application 402 does not require a root process listening on a PF_KEY socket. Referring to step 502, the Linux operating system kernel 106 performs its normal transport layer and IP layer processing to generate the processed data packet.

Referring to step 504, the processed data packet is transmitted to the XFRM encryption framework 316. The XFRM encryption framework 316 checks the packet parameters against the SPD. Since there is a matching rule, the XFRM attempts to find a matching SA entry. No such entry is found since this is the initial packet. The XFRM encryption framework 316 queues the packet and sends an SADB_ACQUIRE message on the PF_KEY socket 310 to the registered modified key management application 402. The modified key management application 402 receives the SADB_ACQUIRE message, and then sends an SADB_GETSPI request to the operating system kernel 106. The operating system kernel 106 allocates a SPI and sends the response through the PF_KEY socket 310. The modified key management application 402 negotiates the SA parameters with the IKE peer of the remote computer. The modified key management application 402 pushes the SA information into the operating system kernel 106 through the PF_KEY socket 310 with an SADB_UPDATE message. The operating system kernel 106 creates the SA entry in the SAD.

Referring to step 506, the modified key management application 402 also pushes the SA information to the second computing device 104 through the relevant driver API. The encryption module 114 creates an SA entry in a local SAD.

Referring to step 508, the operating system kernel 106 XFRM encryption framework 316 dequeues the packets waiting on the SA. The operating system kernel 106 locates the highest precedence encryption module for the AES protocol, the bypass encryption module 202. The operating system kernel 106 invokes the bypass encryption module 202's encrypt algorithm with the keying information and the packet. The bypass encryption module 202 performs any necessary fixups to the processed data packet (but does not alter the plaintext packet contents) to produce the unencrypted data packet. The bypass encryption module 202 returns success to the operating system kernel 106 indicating that it has “encrypted” the packet.

Referring to step 510, the XFRM encryption framework 316 transmits the unencrypted data packet to the link driver module 320, which performs typical link layer activities (such as adding the link layer header) and transfers the packet to the second computing device 104. Referring to step 512, the encryption module 114 extracts the SPI from the packet and checks for a matching SA entry in the local SAD. This check can find the SA previously added by the modified key management application 402. The encryption module 114 encrypts the packet in place using the keying information from the SA to generate the encrypted data packet. Referring to step 514, the encryption module 114 transmits the encrypted data packet to the link driver module 324. The link driver module 324 performs any additional link processing (such as computing the CRC32 on the final packet contents) and then forwards the encrypted data packet onto the network.

The processing described in the example above is somewhat simplified for subsequent packet(s). Referring to step 504, the sequence of steps associated with the negotiation and installation of the SA are unnecessary. For example, if a matching SA was already installed, the SAD lookup can find the SA and the remaining processing can immediately proceed (e.g., step 504 is completed and the method 500 proceeds to step 506). As another example, the subsequent packet can be queued while the SA was already requested, but not yet installed, and the packet can be queued until the SA is installed.

FIG. 7 is a method 700 for decrypting a data packet using loosely-coupled encryption functionality according to a first embodiment. Referring to FIGS. 3-4, at step 702 the second computing device 104 receives (via link driver module 324) an encrypted data packet transmitted from a remote computer to the first computing device 102. At step 704, the encryption module 114 determines encryption information including one or more parameters for encrypting and decrypting data packets transmitted between the first computing device 102 and the remote computer. At step 706, the encryption module 114 decrypts the encrypted data packet based on the encryption information to generate an unencrypted data packet. At step 708, the encryption module 114 transmits the unencrypted data packet to the first computing device 102. At step 710, the first computing device 102 executes a bypass encryption routine (e.g., being executed by the bypass encryption module 202) to generate a processed data packet. The bypass encryption routine does not modify the unencrypted data packet. At step 712, the operating system processes the processed data packet through one or more internet protocol stack layers to generate a data packet (e.g., through the routing module 314 and the IP processing module 312, and eventually to the user-space application via socket 308.

Referring to step 704, for input packets, some encryption frameworks (e.g., IPsec) dictate that the sender of a packet is responsible for creating the encryption information if it does not already exist (e.g., initiating an SA negotiation if a matching SA does not exist). Consequently, on the receiving side (the switch), there is first a negotiation to create the encryption information (via the negotiation module) before the first packet is transmitted by the remote computer. The transmission process by the remote computer begins with creating the encryption information. For example, the remote computer can initiate the key negotiation between the remote key management application (the key management application in the negotiation module of the first computing device 102) and the local key management application on the remote computer. When the SA parameters are determined, the key management application pushes the SA information into the operating system 106. The negotiation module also transmits a message 326 to the second computing device 104 indicative of the encryption information. For example, referring to FIG. 3, the snoop application 304 sees the SA information transmitted by the unmodified key management application 302 to the OS encryption framework 316 and transmits the encryption information via message 326 to the encryption module 114.

Referring to step 706, when the encrypted packets are received by the second computing device 104, the encryption module 114 uses the encryption information (e.g., SA information stored in the database 116 of FIG. 1) to decrypt the packet and forward to the link driver module 320 in the operating system 106. In some embodiments, the encryption module 114 is configured to not remove encryption header information. For example, for IPsec, the encryption module 114 can be configured to not remove the encapsulating security payload (ESP, which provides origin authenticity, integrity, and confidentiality) header and/or IPsec authentication headers (AH, which protects the data packet header, unlike ESP). For IPsec tunnel mode, the encryption module 114 can be configured to not remove the outer IP header. The XFRM layer also determines the relevant SA information in the SAD and invokes the registered decrypt module. The decrypt module does a simulated (fake) decrypt and then the XFRM continues with rest of the local packet processing.

The example described above with reference to FIG. 5 is continued here to provide an example of ingress packet processing. The encryption information (SAs) is negotiated by the sending remote computer. For ingress packets, the method 700 starts with the peer initiating a SA negotiation. The Racoon2 unmodified key management application 302 receives the SA negotiation request from the remote computer. The Racoon2 unmodified key management application 302 transmits an SADB_GETSPI request to the operating system kernel 106 to request a SPI. The operating system kernel 106 allocates a SPI and sends the response to Racoon2 unmodified key management application 302. The Racoon2 unmodified key management application 302 completes the SA negotiation. The Racoon2 unmodified key management application 302 pushes the SA information into the operating system kernel 106 with an SADB_UPDATE message. The operating system kernel 106 installs the SA into the SAD. The snoop application 304 sees the GETSPI request and response (but does not need to act on it). The snoop application 304 also sees the SADB_UPDATE with the SA information. The snoop application 304 sends the SA information to the second computing device 104 through message 326. The encryption module 114 on the second computing device 104 creates an SA entry in a local SAD.

Referring to step 702, the remote computer sends an encrypted packet to the switch. The link driver module 324 executes the necessary link layer processing and sends the encrypted data packet to the encryption module 114. Referring to step 704, the encryption module 114 looks up the SA using the SPI from the encrypted data packet. Referring to step 706, the keying information from the SA is used to decrypt the packet in place to generate the unencrypted data packet. In this example, the IPsec ESP and/or AH headers are not removed or modified, nor is the outer IP header removed for tunnel mode IPsec connections.

Referring to step 708, the unencrypted data packet is delivered to the link driver module 320 in the Linux operating system kernel 106. The link driver does any necessary additional processing (e.g., remove the link layer header). The link driver module 320 transmits the unencrypted data packet to the XFRM encryption framework 316. Referring to step 710, the XFRM encryption framework 316 looks up the SA from the SPI in the unencrypted data packet. The operating system kernel 106 finds the encryption module for the SA, the bypass encryption module 202. The SA keying information and the pseudo-encrypted packet are passed into the bypass encryption module 202 decrypt routine. The bypass encryption module 202 performs any ancillary decryption activities (e.g., padding removal). Referring to step 712, the operating system kernel 106 performs all normal additional IP processing (e.g., local routing, transport layer processing, delivery into a socket, etc.).

The switch (e.g., the first computing device 102 and the second computing device 104) can be configured to process and discard erroneous data packets. For example, the second computing device 104 can be configured to reject packets sent by a remote computer that are created with an invalid SPI. Referring to step 702, the remote computer sends an encrypted data packet with an ESP and/or AH IPsec header containing an invalid SPI. The link driver module 324 performs the necessary link layer processing and sends the encrypted data packet to the encryption module 114. Referring to steps 704-706, the SPI in the encrypted data packet is invalid so the encryption module 114 does not find an SA in the SAD (e.g., the SPI expired, etc.). Referring to step 708, the encryption module 114 transmits the encrypted data packet to the link driver module 320 in the Linux operating system kernel 106 without change. The link driver module 320 does any necessary additional processing (e.g., removing the link layer header). Referring to step 710, the encrypted data packet is transmitted to the XFRM encryption framework 320. The encrypted data packet has an invalid SPI so the XFRM encryption framework does not find an SA in the SAD. The XFRM encryption framework 316 drops the packet due to the invalid SPI.

As another example, the switch can be configured to reject a packet when the remote computer sends a plaintext packet when it should have negotiated an SA and sent encrypted and/or authenticated packets. Referring to step 702, the remote computer sends a plaintext packet (no IPsec ESP or AH header) without establishing an SA. The link driver module 324 does the necessary link layer processing and sends the packet to the encryption module 114. Referring to steps 704-706, there is no IPsec header so the encryption module 114 can perform plaintext handling (e.g., basic IP packet validation) but does not decrypt the packet. Referring to step 708, the encryption module 114 transmits the packet to the link driver module 320 in the Linux operating system kernel 106. The link driver module 320 does any necessary additional processing, and transmits the packet to the XFRM encryption framework 316. Referring to step 710, the packet has no IPsec header so the XFRM encryption framework does not try to find an SA. The XFRM encryption framework 316 matches the packet against the SPD for a matching rule. A matching rule that requiresAES encryption is found. Since AES is required, but the packet has no IPsec header, the XFRM encryption framework 316 discards the packet.

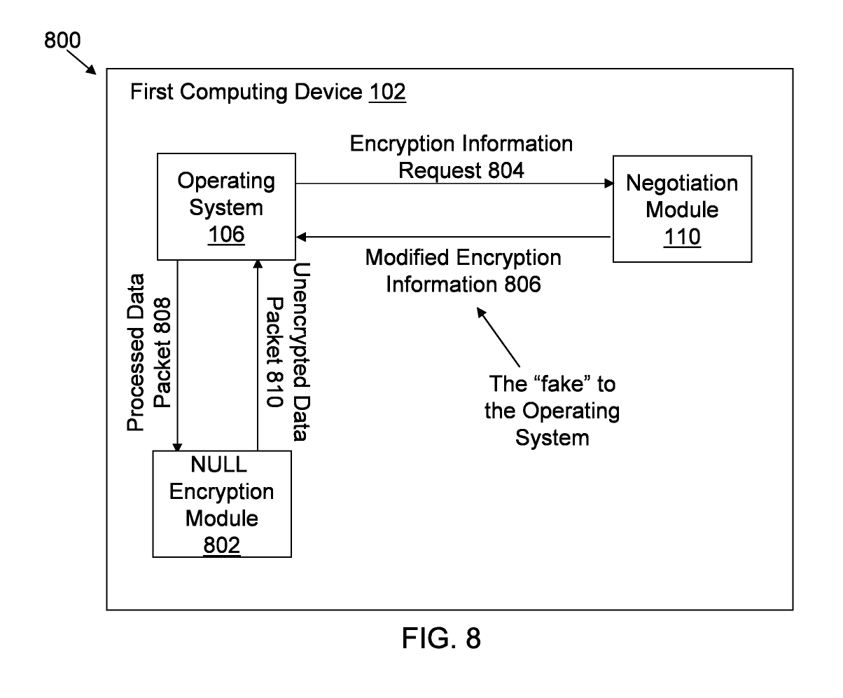

FIG. 8 illustrates an architectural diagram 800 of an operating system 106 in the first computing device 102 of FIG. 1 being faked to not encrypt a processed data packet according to a second embodiment. The operating system 106 is in communication with the negotiation module 110 and a null encryption module 802. The operating system 106 sends an encryption information request 804 (e.g., key negotiation request) to the negotiation module 110. The negotiation module sends modified encryption information 806 to the operating system 106. The operating system 106, using the modified encryption information 206, sends the processed data packet 808 (e.g., via a scatter/gather API) to the null encryption module 802. The null encryption module 802 executes a null encryption routine to generate an unencrypted data packet 810. The bypass encryption module 802 transmits the unencrypted data packet 810 to the operating system 106.

The operating system 106 is faked into calling the null encryption module 802 upon receipt of the modified encryption information 806. In the encryption information request 804, the operating system 106 asks for a particular type of encryption information (e.g., AES), the negotiation module 110 negotiates AES encryption information, but the negotiation module 110 returns the modified encryption information 806 that includes instructions for the operating system 106 to call the null encryption module 802. The null encryption module can be a commonly supported null encryption routine built into many operating systems that performs no processing of the processed data packet 808. For example, the modified encryption information 806 includes instructions that cause the operating system to perform null encryption so the operating system 106 never invokes an encryption module. To the operating system 106, there is no difference from an encryption information request standpoint (e.g., the operating system 106 requests a key negotiation from the negotiation module 110 as it can with any other negotiation module). Advantageously, this unchanged view from the operating system 106 allows the operating system 106 to receive the modified encryption information 806 from the negotiation module 110 without requiring any changes to operating system kernel 106 core.

FIG. 9 illustrates an architectural diagram of a switch 900 that incorporates loosely-coupled encryption functionality for an operating system according to a second embodiment using a modified key management application 902. Similar to FIGS. 3 and 4, the switch 900 includes the first computing device 102 in communication with the second computing device 104. The first computing device 102 includes the operating system 106 which is in communication with the negotiation module 906 through sockets 308 and 310. The operating system 106 includes IP processing module 312, which is in communication with the socket 308 and the routing module 314. The routing module 314 is in communication with the OS encryption framework 316. The OS encryption framework 316 is in communication with the modified key management application 902 of the negotiation module 906 via socket 310. The OS encryption framework 316 is also in communication with the null encryption module 908 and the link driver module 320. The second computing device 104 includes encryption module 114 which is in communication with the link driver module 324. The modified key management application 902 transmits the message 326 to the encryption module 114.

The modified key management application 902 performs the encryption information (e.g., security key) negotiation and establishes the security association between the first computing device 102 and a remote computer. The modified key management application 902 can also maintain the lifetime of the negotiated encryption information and perform re-negotiation when appropriate. In some examples, the modified key management application 902 can re-negotiate encryption information when traffic that uses a specific encryption information (e.g., SA) has reached a certain number of bytes to prevent pattern matching. In some embodiments, a configuration system is in communication with the modified key management application 902. For example, the configuration system can be a user interface which provides functionality to configure the negotiation module 906.

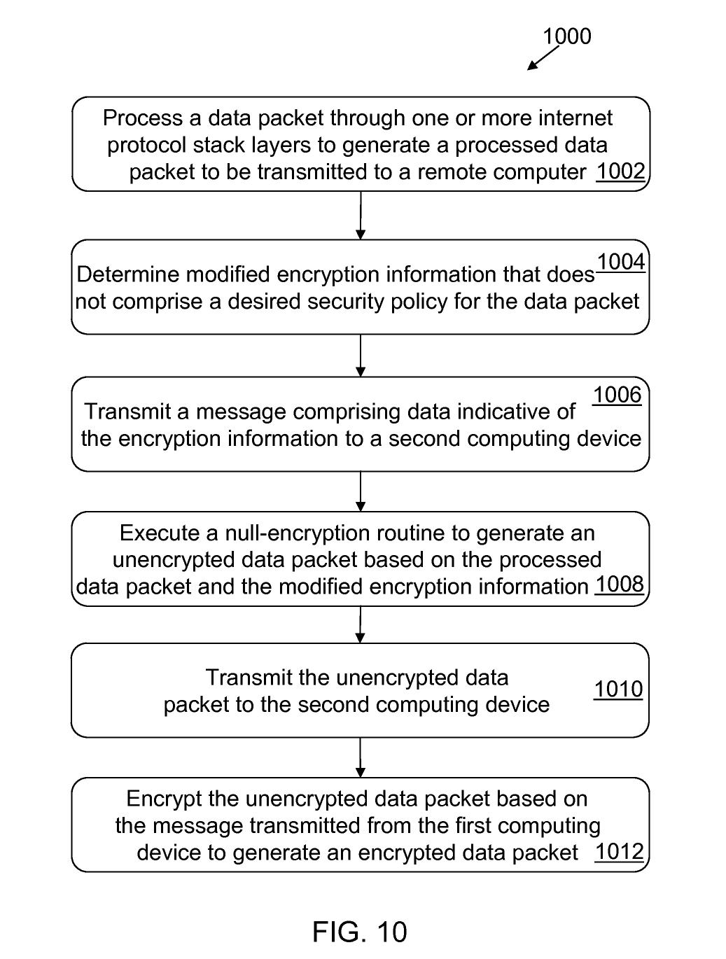

FIG. 10 is a method 1000 for encrypting a data packet using loosely-coupled encryption functionality according to a second embodiment. Referring to FIG. 9, at step 1002 the operating system 106 processes a data packet through one or more internet protocol stack layers (e.g., via the IP processing module 312 and the routing module 314) to generate a processed data packet to be transmitted to a remote computer. At step 1004, the OS encryption framework 316 determines modified encryption information that does not comprise a desired security policy for the data packet. At step 1006, the modified key management application 902 transmits the message 326 comprising data indicative of the encryption information to the encryption module 114 of the second computing device 104. The operating system 106 being executed by the first computing device 102 is unaware of a security nature the transmission. At step 1008, the OS encryption framework 316 executes a null-encryption routine (e.g., via the null encryption module 908) to generate an unencrypted data packet based on the processed data packet and the modified encryption information. The null-encryption routine does not encrypt the processed data packet (e.g., the unencrypted data packet comprises plaintext). In some embodiments, while the bypass encryption module (e.g., 202 of FIGS. 3-4) can perform some processing to data packets, the null-encryption routine is configured to not process the data packet at all (e.g., perform no processing of the data packet). At step 1010, the link driver module 320 transmits the unencrypted data packet to the second computing device 104. At step 1012, the encryption module 114 encrypts the unencrypted data packet based on the message 326 transmitted from the first computing device 102 to generate an encrypted data packet.

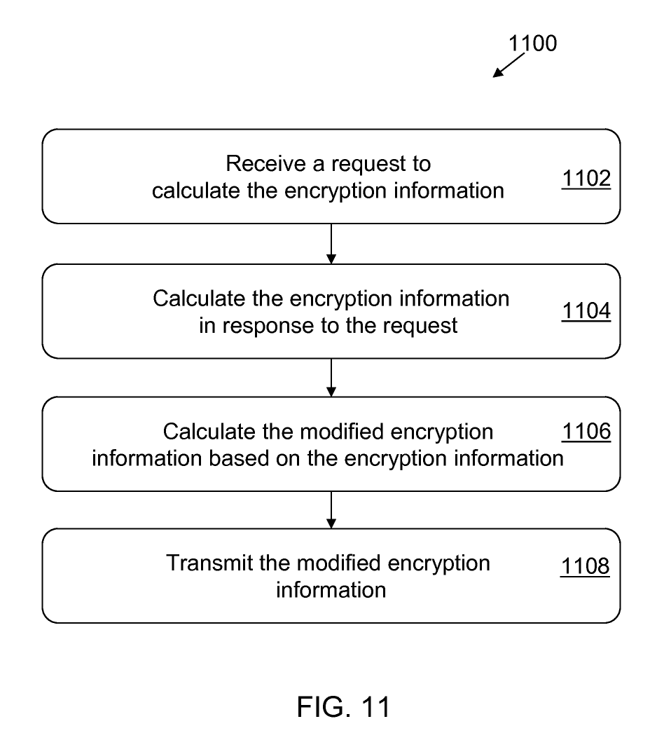

Referring to step 1004, if the negotiation module 906 previously calculated the encryption information and/or modified encryption information for sessions between the first computing device 102 and the remote computer, the OS encryption framework can determine the modified encryption information by retrieving the modified information from a database in communication with the first computing device (e.g., database 112 of FIG. 1). For the first data packet, for example, the negotiation module 906 may not yet have calculated the encryption information and/or modified encryption information. The OS encryption framework 316 can transmit a request for the encryption information to the modified key management application 902, and receive the modified encryption information from the modified key management application 902. FIG. 11 describes this process in more detail.

Referring to step 1006, the message 326 comprises data indicative of the actual encryption information. For example, the message can include the decryption ID mapping, the encryption ID mapping, information indicative of the actual encryption parameters, and/or information indicative of the actual integrity parameters. Advantageously, once the encryption module 114 receives the message 326, all data packets transmitted between the first computing device 102 and the remote computer can be encrypted/decrypted according to the encryption information (e.g., according to a negotiated SA). Other parameters, such as the lifetime of the encryption information, etc. can be maintained by the operating system 106 (e.g., via the OS encryption framework).

Referring to steps 1008-1010, the unencrypted data packet includes data indicative of the modified encryption information. Referring to step 1012, the encryption module uses the data indicative of the modified encryption information in the unencrypted data packet to encrypt the packet. For example, for IPsec, the OS encryption framework 316 (e.g., the XFRM framework) creates an Encapsulating Security Payload (ESP) header for the unencrypted data packet, which includes the decryption ID and encryption ID. The encryption module 314 uses the decryption ID and/or encryption ID to calculate the encrypted data packet. The encryption module 314 can replace the ESP header created by the OS encryption framework 316 with an ESP header that includes the proper ESP information (e.g., the actual SPIs, actual encryption information, and actual integrity information).

FIG. 11 is a method 1100 for calculating modified encryption information using loosely-coupled encryption functionality according to a second embodiment. At step 1102, the negotiation module 906 (e.g., the modified key management application 902) receives a request to calculate the encryption information (e.g., from the OS encryption framework 316). At step 1104, the negotiation module 906 calculates the encryption information in response to the request received in step 1102. At step 1106, the negotiation module 906 calculates the modified encryption information based on the encryption information. At step 1108, the negotiation module 906 transmits the modified encryption information to the requesting device (e.g., the OS encryption framework 316).

Referring to step 1104, the modified key management application 902 determines/negotiates encryption information, which includes one or more parameters for encrypting and decrypting data packets transmitted between the first computing device 102 and the remote computer (e.g., a Security Parameter Index (SPI) for the first computing device 102, a SPI for the remote computer, actual encryption information, actual integrity information). The encryption information comprises the desired security policy for data packets transmitted between the first computing device 102 and the remote computer. For example, the encryption information can include a security association between the first computing device 102 and the remote computer. The security association comprises a security parameter index (SPI) and one or more encryption parameters and/or integrity parameters. The request for encryption information can include a request for any non-null encryption policy. In some embodiments, the request for the encryption information (received in step 1102) comprises a request for an advanced encryption standard (AES) encryption policy, and the encryption information comprises an AES policy.

Referring to step 1106, the modified key management application 902 calculates encryption context identifier(s) for the second computing device 104 (e.g., for the encryption module 114). For example, the encryption context identifiers include a decryption ID mapping and an encryption ID mapping for the encryption module 114 (e.g., which map a decryption ID of the encryption module 114 to the SPI for the first computing device 102 and an encryption ID of the second computing device 104 to the SPI for the remote computer, respectively). The modified key management application 902 determines the modified encryption information based on encryption information. For example, the modified encryption information includes the decryption ID, the encryption ID, null encryption parameters (which specify no encryption to the payload) and null authentication parameters (which specify no authentication/integrity) to the OS encryption framework 316. Advantageously, the modified encryption information instructs the OS encryption framework 316 to execute a null encryption routine on the processed data packet, while the message 326 provides the encryption module 114 with the encryption parameters necessary to encrypt/decrypt packets transmitted between the first computing device 102 and the remote computer. The negotiation module 906 may include a resource manager (not shown) in communication with the modified key management application 902 configured to perform some of the functionality described above with respect to the modified key management application 902.

The operating system can include one or more configuration parameters (e.g., that can be configured at the Application Level). The operating system can receive data indicative of the one or more configuration parameters separately from the modified encryption information (e.g., the data can be calculated based on the encryption information). In one example, the operating system can receive data indicative of a fragmentation configuration parameter. The fragmentation configuration parameter can include data indicative of a maximum size for data packets (e.g., the maximum segment size (MSS), which is the largest amount of data, specified in bytes, that the operating system can handle in a single, unfragmented piece).

The maximum size for the operating system 106 can be determined based on the maximum size used by the second computing device 104 (e.g., used by the encryption module 114). For example, assume the encryption module 114 is configured to perform AES encryption, which adds a 40 byte header to the encrypted data packet. Further assume that the second computing device 104 is configured with a maximum size of 1500 bytes (e.g., based on a maximum transmission unit (MTU), the maximum size of a data packet that can be transmitted to the network 120). In some examples, it is desirable to have any fragmentation performed by the first computing device 102 and to avoid/prevent fragmentation by the second computing device 104 (e.g., so the second computing device 104 can add the 40 byte header to each packet without going over its set maximum size of 1500 bytes). The operating system 106 can be configured with a maximum size of 1460 bytes for a data packet (e.g., the maximum size of a data packet that is transmitted from the operating system 106). For example, if the operating system 106 processes an unencrypted data packet that includes 1485 bytes (which is greater than the maximum allowed 1460 bytes), the operating system 106 fragments the unencrypted data packet into a first fragmented unencrypted data packet and a second fragmented unencrypted data packet, both of which include less than 1460 bytes. Advantageously, the second computing device 104 (e.g., the encryption module 114) can add the difference between the maximum size of the second computing device 104 and the maximum size of the operating system 106 (e.g., 1500 bytes−1460 bytes=40 bytes) to the encrypted data packet and transmit the encrypted data packet without fragmenting the encrypted data packet (because the largest packet the second computing device 104 can receive is 1460 bytes from the operating system 106). This can prevent fragmentation by the second computing device 104.

Referring to step 1108, if the requesting device was the OS encryption framework 316, the negotiation module 906 can transmit the modified encryption information to the OS encryption framework 316. The OS encryption framework 316 can locally store the modified encryption information. The modified key management application 902 can be configured to transmit the encryption information to the second computing device 104.

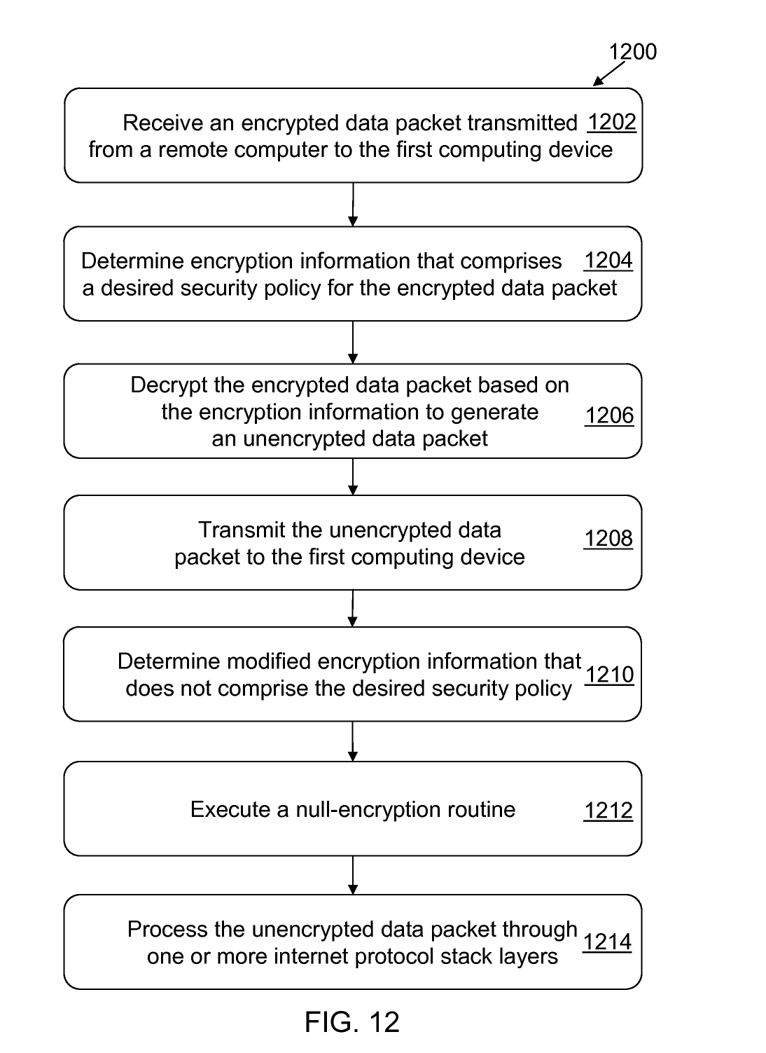

FIG. 12 is a method 1200 for decrypting a data packet using loosely-coupled encryption functionality according to a second embodiment. Referring to FIG. 9, at step 1202 the second computing device 104 receives (e.g., via the link driver module 324) an encrypted data packet transmitted from a remote computer to the first computing device 102. At step 1204, the encryption module 114 determines encryption information (e.g., by identifying the encryption information in database 116 of FIG. 1) that comprises a desired security policy for the encrypted data packet. The encryption information includes one or more parameters for encrypting and decrypting data packets transmitted between the first computing device 102 and the remote computer (e.g., encryption parameters and/or integrity parameters). At step 1206, the encryption module 114 decrypts the encrypted data packet based on the encryption information to generate an unencrypted data packet. At step 1208, the encryption module 114 transmits the unencrypted data packet to the first computing device 104 (e.g., via the link driver module 320). At step 1210, the OS encryption framework 316 determines modified encryption information that does not comprise the desired security policy. The modified encryption information includes, for example, one or more null parameters (e.g., null encryption parameters and null integrity parameters). At step 1212, the OS encryption framework 316 executes a null-encryption routine (e.g., via the null encryption module 908). The null-encryption routine does not modify the unencrypted data packet. At step 1214, the operating system 106 processes the unencrypted data packet through one or more internet protocol stack layers (e.g., via routing module 314 and IP processing module) to generate a data packet.

Referring to step 1206, in some embodiments the encryption module 114 can reconstruct a packet header for the unencrypted data packet. For example, the encrypted data packet can comprise an ESP header comprising SPIs, actual encryption information, and actual integrity information. The operating system 106, upon receipt of this ESP header, need not receive instructions to invoke a null-decryption routine. The encryption module 114 can create a new ESP header that includes a decryption ID for the encryption module, null encryption parameters, and/or null integrity parameters. Advantageously, the operating system 106 receives the unencrypted data packet and, based on the reconstructed packet header, invokes a null-decryption routine (and therefore does not perform any decryption processing on the unencrypted data packet) but still executes other encryption framework processing for the unencrypted data packet.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. An encryption apparatus comprising a first computing device in communication with a second computing device, wherein:
the first computing device comprises:
an operating system configured to:
process a data packet through one or more internet protocol stack layers to generate a processed data packet to be transmitted to a remote computer;
determine encryption information including one or more parameters for encrypting and decrypting data packets transmitted between the first computing device and the remote computer; and
execute a bypass encryption routine to generate an unencrypted data packet based on the processed data packet, wherein the bypass encryption routine does not encrypt the processed data packet; and
transmit the unencrypted data packet to the second computing device; and
a negotiation module in communication with the operating system and the second computing device configured to transmit a message comprising data indicative of the encryption information to the second computing device, wherein the operating system is unaware of a security nature of the transmission; and
the second computing device comprising an encryption module configured to encrypt the unencrypted data packet based on the message transmitted from the first computing device to generate an encrypted data packet.

2. The apparatus of claim 1, wherein the second computing device is further configured to transmit the encrypted data packet to the remote computer.

3. The apparatus of claim 1, wherein the negotiation module is configured to:
generate the encryption information;
transmit the encryption information to the operating system through a socket; and
transmit the message comprising data indicative of the encryption information to the second computing device.

4. The apparatus of claim 3, wherein the negotiation module comprises:
an unmodified key management application and a snoop application configured to monitor the socket to generate the message; or
a modified key management application.

5. The apparatus of claim 1, further comprising a database in communication with the first computing device, and wherein determining the encryption information comprises retrieving the encryption information from the database.

6. The apparatus of claim 1, wherein the first computing device comprises a bypass encryption module in communication with the operating system configured to:
receive the processed data packet from the operating system;
execute the bypass encryption routine to generate the unencrypted data packet; and
transmit the unencrypted data packet to the operating system.

7. The apparatus of claim 6, wherein the encryption module is configured to add one or more padding bytes to the processed data packet to generate the unencrypted data packet.

8. The apparatus of claim 1, wherein the first computing device is a main processor and the second computing device is a network processor.

9. The apparatus of claim 1, wherein the operating system is Linux and the operating system comprises an IPsec implementation.

10. The apparatus of claim 1, wherein the bypass encryption routine comprises a user-specified bypass encryption routine that is separate from the operating system and does not require modification of the operating system to install the bypass encryption routine, wherein the operating system processes the unencrypted data packet as if the unencrypted data packet were an encrypted data packet.

11. A computerized encryption method comprising:
processing, by a first computing device, a data packet through one or more internet protocol stack layers to generate a processed data packet to be transmitted to a remote computer;
determining, by the first computing device, encryption information including one or more parameters for encrypting and decrypting data packets transmitted between the first computing device and the remote computer;
transmitting, by the first computing device, a message comprising data indicative of the encryption information to a second computing device, wherein an operating system being executed by the first computing device is unaware of a security nature of the transmission;
executing, by the first computing device, a bypass encryption routine to generate a unencrypted data packet, wherein the bypass encryption routine does not encrypt the processed data packet;
transmitting, by the first computing device, the unencrypted data packet to the second computing device; and
encrypting, by the second computing device, the unencrypted data packet based on the message transmitted from the first computing device to generate an encrypted data packet.

12. The method of claim 1, further comprising transmitting, by the second computing device, the encrypted data packet to the remote computer.

13. The method of claim 1, wherein determining the encryption information comprises determining whether a security association between the first computing device and the remote computer is stored in a database.

14. The method of claim 13, further comprising, if a security association for the first computing device and the remote computer is not stored in the database, determining a security association for the first computing device and the remote computer.

15. The method of claim 1, wherein a key management application is modified to transmit the message comprising data indicative of the encryption information to the second computing device.

16. The method of claim 1, further comprising:
transmitting a request for encryption information between the first computing device and the remote computer to an unmodified key management application using a socket; and
receiving from the unmodified key management application data indicative of the encryption information for the first computing device and the remote computer using the socket.

17. The method of claim 16, wherein a snoop application monitors the socket to determine the message comprising data indicative of the encryption information.

18. The method of claim 1, wherein executing the bypass encryption routine comprises adding one or more padding bytes to the processed data packet to generate the unencrypted data packet.

19. The method of claim 1, wherein the unencrypted data packet comprises original plaintext from the data packet.

20. The method of claim 1, wherein executing the bypass encryption routine comprises:
transmitting, by an operating system, the processed data packet to the bypass encryption routine through an application programming interface, wherein the bypass encryption routine is registered with the operating system; and
receiving, by the operating system, the unencrypted data packet from the bypass encryption routine, wherein the operating system processes the unencrypted data packet as if the unencrypted data packet were an encrypted data packet.

21. A computerized decryption method executed by a decryption apparatus comprising a first computing device and a second computing device, the method comprising:
receiving, by the second computing device, an encrypted data packet from a remote computer to the first computing device;
determining, by the second computing device, encryption information including one or more parameters for encrypting and decrypting data packets transmitted between the first computing device and the remote computer;
decrypting, by the second computing device, the encrypted data packet based on the encryption information to generate an unencrypted data packet;
transmitting, by the second computing device, the unencrypted data packet to the first computing device;
executing, by the first computing device, a bypass decryption routine to generate a processed data packet, wherein the bypass decryption routine does not modify the unencrypted data packet; and
processing, by the first computing device, the processed data packet through one or more internet protocol stack layers to generate a data packet.

22. A decryption apparatus comprising a first computing device in communication with a second computing device, wherein:
the second computing device is configured to:
receive an encrypted data packet from a remote computer to a first computing device;
determine encryption information including one or more parameters for encrypting and decrypting data packets transmitted between the first computing device and the remote computer;
decrypt the encrypted data packet based on the encryption information to generate an unencrypted data packet; and
transmit the unencrypted data packet to the first computing device;
the first computing device comprises an operating system configured to:
execute a bypass decryption routine to generate a processed data packet, wherein the bypass decryption routine does not modify the unencrypted data packet; and
process the processed data packet through one or more internet protocol stack layers to generate a data packet.
